(19) United States
(12) Patent Application Publication
(10) Pub. No.: US 2025/0346123 A1
(43) Pub. Date: Nov. 13, 2025

(54) MULTI-ZONAL VEHICLE ARCHITECTURE

(71) Applicant: Rivian IP Holdings, LLC, Irvine, CA (US)

(72) Inventors: Sanjeewa Keven SUGATAPALA, Long Beach, CA (US); Thomas ROCROI, Richmond, CA (US); Frederik Francois BOTES, Ontario, CA (US); Kyle LOBO, Westchester, CA (US); Ajay KUMAR, Phoenix, AZ (US); Long Phi HUYNH, Brea, CA (US); Steven HANG, Long Beach, CA (US)

(21) Appl. No.: 19/170,359

(22) Filed: Apr. 4, 2025

Related U.S. Application Data
(60) Provisional application No. 63/643,432, filed on May 7, 2024.

(51) Int. Cl. B60L 3/00; B60K 35/80; B60L 1/00; B60L 1/14; B60R 16/033

(52) U.S. Cl. CPC B60L 3/0084; B60K 35/80; B60L 1/003; B60L 1/14; B60L 3/0015; B60L 3/0092; B60R 16/033; B60L 2210/10

(57) ABSTRACT

A vehicle may include an east electronic control unit (ECU), a west ECU, or a third ECU. The first ECU may operate first components on a first side of a longitudinal axis of the vehicle, while the second ECU may operate second components on a second side of the longitudinal axis. The longitudinal axis may be defined as an imaginary line running from the front of the vehicle to the rear along its center, dividing the vehicle into the first and second sides. The third ECU may be positioned at the rear of the vehicle.

### CROSS REFERENCE TO RELATED APPLICATION(S)

The present application claims the benefit of U.S. Provisional Application No. 63/643,432, entitled “MULTI-ZONAL VEHICLE ARCHITECTURE”, filed May 7, 2024, the entirety of which is incorporated herein for reference.

### INTRODUCTION

This application is directed to zonal architecture for functional and power distribution, and more particularly, associated with an electric vehicle.

### SUMMARY

The disclosed subject matter provides for zonal architecture for power distribution that allows for redundancy in power distribution. A vehicle may include a first electronic control unit (ECU), a second ECU, or a third ECU. The first ECU may operate first components on a first side of a longitudinal axis of the vehicle, while the second ECU may operate second components on a second side of the longitudinal axis. The longitudinal axis may be defined as an imaginary line running from the front of the vehicle to the rear along its center, dividing the vehicle into the first and second sides. The third ECU may be positioned at the rear of the vehicle.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates an exemplary overhead view of a vehicle with zonal power distribution.

FIG. 1B illustrates an exemplary side view of a vehicle with zonal power distribution.

FIG. 1C illustrates an example of wiring or positioning of components of a vehicle.

FIG. 1D illustrates an example of wiring or positioning of components of a vehicle.

FIG. 1E illustrates an example of wiring or positioning of components of a vehicle.

FIG. 1F illustrates an example of wiring or positioning of components of a vehicle.

FIG. 1G illustrates an example overhead view of a vehicle associated with wiring, connection, or positioning of components.

FIG. 2 illustrates an example block diagram of a system with zonal power distribution as described herein.

FIG. 3A illustrates an exemplary method for power bus switching.

FIG. 3B illustrates an exemplary method for power bus switching.

FIG. 3C illustrates an exemplary method for power bus switching.

FIG. 4 illustrates an exemplary block diagram of power distribution components or functionality.

FIG. 5 illustrates an exemplary block diagram of power distribution components or functionality.

FIG. 6 illustrates an exemplary block diagram of components or functionality of a vehicle.

FIG. 7 illustrates an exemplary network associated with vehicle network component communication.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Some vehicles have domain based electronic control units (ECUs) for the different vehicle features. In an example, domains, such as doors, windows, wipers, headlamps, or the like, may have a dedicated ECU. In such an approach, for example, the wires that come from the motors in the door may be routed to a first ECU, the lights may be routed to a second ECU, and the temperature sensors may be routed to a third ECU, which may provide for extensive wiring, complexity to repair and install, or cost.

The disclosed subject matter provides for a zonal architecture for power distribution that allows for redundancy in power distribution and therefore may protect against the loss of one or more power buses or electronic control units (ECUs). The ECU functions of the zonal architecture may be based on geographic zone of a vehicle, such as front left, front right, or rear zone. In addition, there may be two or more power sources for low voltage power distribution. In an example, each ECU may be provided continuous power from direct current to direct current converter (DCDC) wherein the DCDC steps down from a high voltage battery pack and may be provided power from a low voltage (LV) battery (e.g., 12V battery). Each ECU may be powered by either DCDC or LV Battery. As further described herein, if there is a fault on a first power source (e.g., DCDC bus), then a second power source (e.g., LV battery bus) may power the vehicle to operate one or more functions, which may be functions associated with critical tasks. For example, the advanced driver assistance system (ADAS) system of the vehicle may continue to be powered to keep the vehicle moving appropriately until a user takes over. In addition, there may be redundant functions for each ECU, therefore, if a first ECU fails, a second ECU may continue to operate the redundant functions or other ECU specific functions.

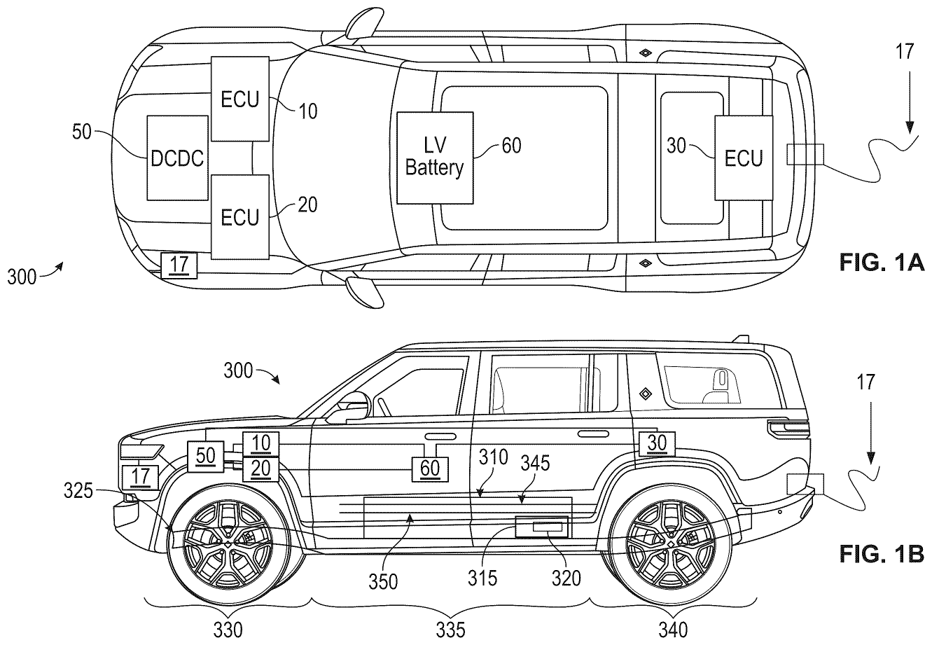

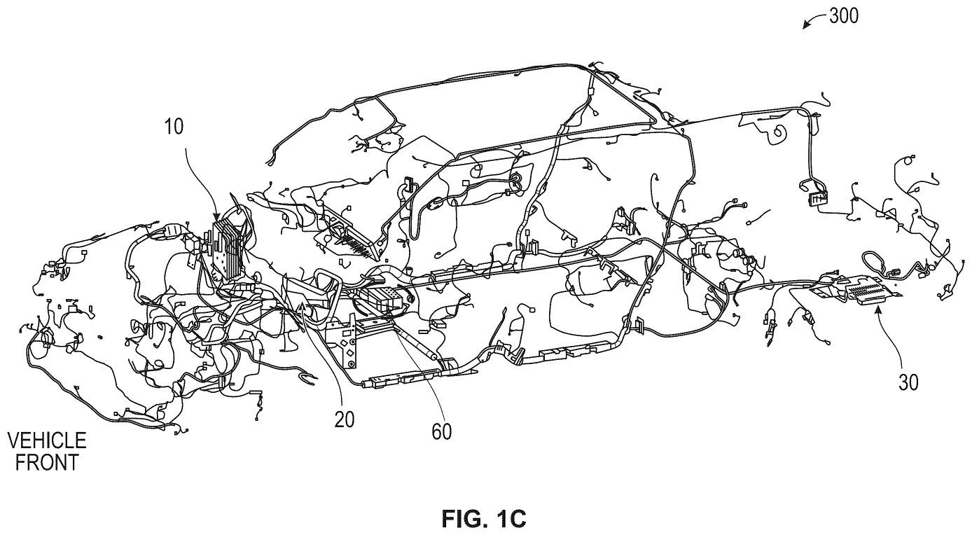

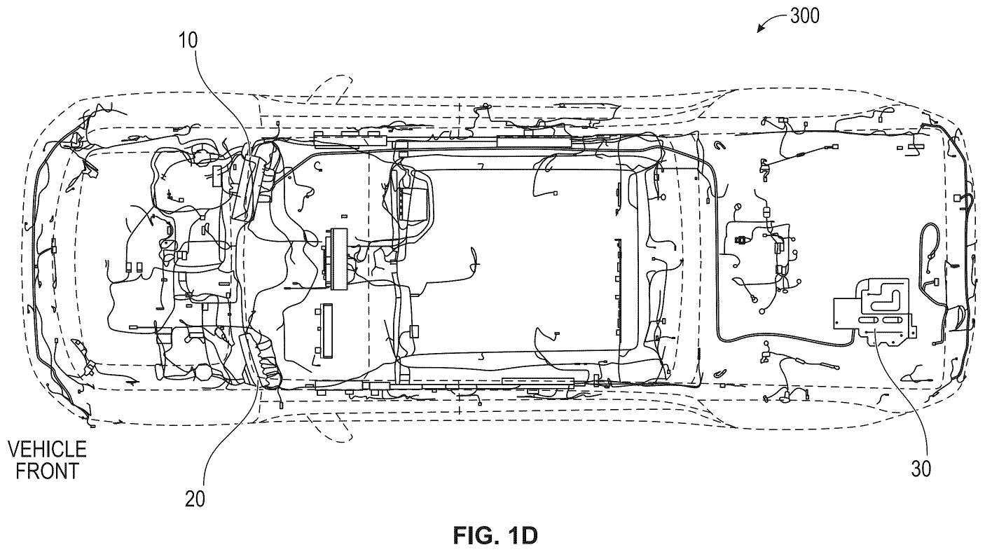

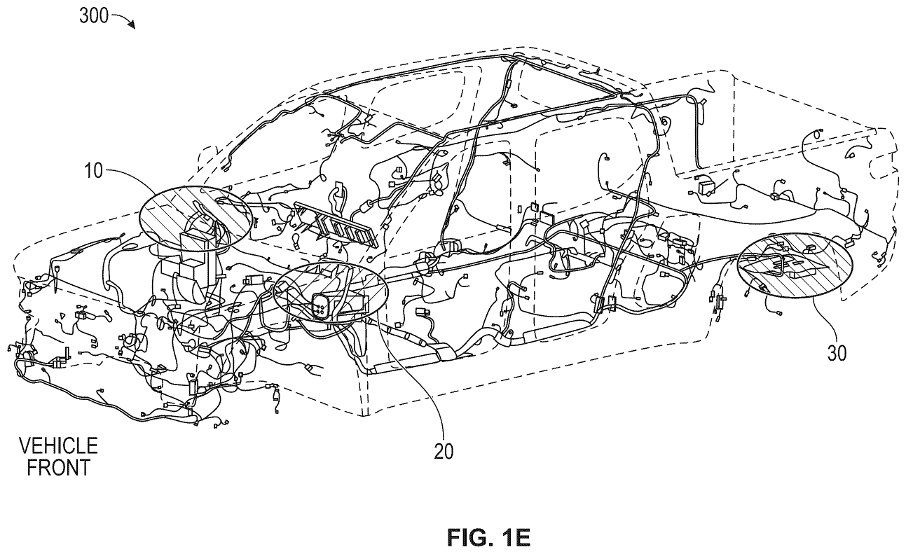

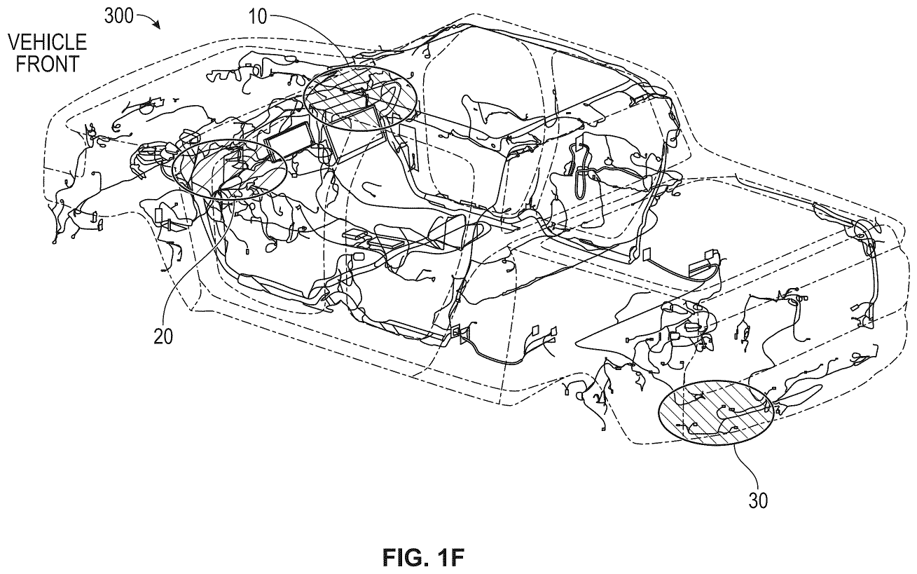

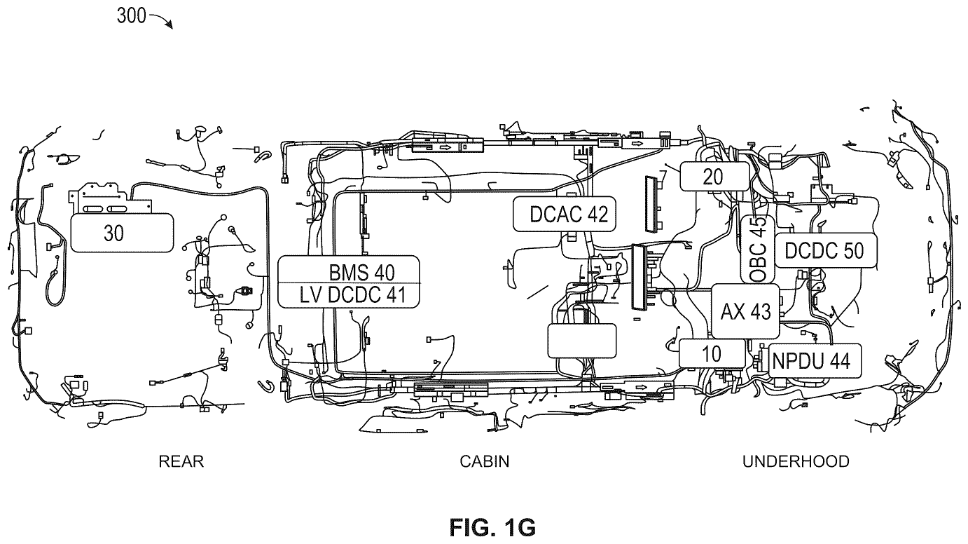

FIG. 1A illustrates an example overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), direct current to direct current converter (DCDC) 50, low voltage (LV) battery 60 (e.g., 12V battery), or jumpstart access 17, among other things. As further described herein, ECU 10 may operate components on a first side of a longitudinal axis of vehicle 300, while the ECU 20 may operate components on a second side of the longitudinal axis. The longitudinal axis may be defined as an imaginary line running from the front of vehicle 300 to the rear along its center, dividing vehicle 300 into the first and second sides. ECU 30 may operate components at the rear of vehicle 300.

FIG. 1B illustrates an example side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. As further described herein, ECU 10 (also may be referred to herein as cast zone controller—EZC), ECU 20 (also may be referred to herein as west zone controller—WZC), or ECU 30 (also may be referred to herein as south zone controller—SZC) may be communicatively connected with or have power distributed with each other and may be functionally redundant for power or other operations of electronic components of vehicle 300.

In one or more implementations, the vehicle 300 may be an electric vehicle having one or more electric motors that drive the wheels 302 of the vehicle using electric power from HV battery pack 310. In one or more implementations, the vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 300 may be implemented as a truck (e.g., a pickup truck) having a battery pack 310. As shown, HV battery pack 310 may include on or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 1B, the vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portions 330, center body portion 335, or the rear portion 340). As shown, HV battery pack 310 may include or be electrically coupled with one or more one busbars (e.g., one or more current collector elements). In the example of FIG. 1B, the vehicle 300 includes a first busbar 345 and a second busbar 350, either or both of which may include electrically conductive material to connect or otherwise electrically couple the battery module(s) 315 or the battery cell(s) 320 with other electrical components of the vehicle 300 to provide electrical power to various systems or components of the vehicle 300.

In other implementations, the vehicle 300 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a battery pack 310 (e.g., that powers the propulsion or drive components of the moveable apparatus).

FIG. 1C through FIG. 1G illustrate examples of wiring or positioning of components of vehicle 300. FIG. 1C illustrates an example perspective view of positioning and wiring of ECU 10, ECU 20, and ECU 30. FIG. 1D illustrates exemplary overhead view of positioning and wiring of ECU 10, ECU 20, and ECU 30. ECU 10 may include functionality associated with vehicle righthand functions and power moding. ECU 20 may include functionality associated with vehicle lefthand functions and dynamics. ECU 30 may include functionality associated with distributing local high current devices, such as trailer tow, suspension, auxiliary air, etc., among other things. It is contemplated herein that the functionality or positioning of ECUs may be interchanges, combined, or distributed. In addition, there may be additional ECUs. LV battery 60 (e.g., 10V-14V) may be located within the cabin area, such as under first row passenger seat, which may provide for crash protection, or controlling range of temperatures the battery may be subjected to. FIG. 1E illustrates an example first perspective view of positions for zonal controllers. FIG. 1F illustrates an example second perspective view of positions of zonal controllers. The frame of vehicle 300, as shown in FIG. 1E and in FIG. 1F, is in the form of a truck. ECU 30 may be located under the bed of vehicle 300 and control rear or truck bed related functions.

FIG. 1G illustrates an exemplary overhead view of vehicle 300 associated with wiring, connection, or positioning of components. As shown, vehicle 300 may include ECU 10, ECU 20, ECU 30, BMS 40, LV DCDC 41, direct current to alternating current (DCAC) 42, axial flux motor 43, network protocol data unit (NPDU) 44, or on-board computer 45. An axial flux motor 43 may be incorporated into in wheel or gear box of vehicle 300. Axial flux motors 43 are a type of electric motor in which the magnetic flux may run parallel to the axis of rotation, as opposed to radial flux motors where the flux runs perpendicular. This design allows for a more compact and efficient motor. The wiring as shown in FIG. 1G is generally associated with communication or power distribution between components in the network. The zones may be based on proximity. In an example, if components are geographically closer to a west zone, then those components may be connected with ECU 20, and if components are geographically closer to ECU 10 then those components may be connected with ECU 10.

The disclosed multi-zonal architecture may allow for reduced wiring when compared to other architectures. Shorter wires may provide for less mass and therefore vehicle 300 may weigh less. While wire length generally may not significantly affect cost for small gauge wires, it may influence the overall mass and flexibility of the harness. Longer wires may increase harness bulk, potentially complicating installation due to reduced flexibility. Longer wires may also increase chance of failures. As further disclosed herein, in some cases, incorporating a slightly longer wire to improve system synchronicity may have negligible impact on manufacturing difficulty or cost.

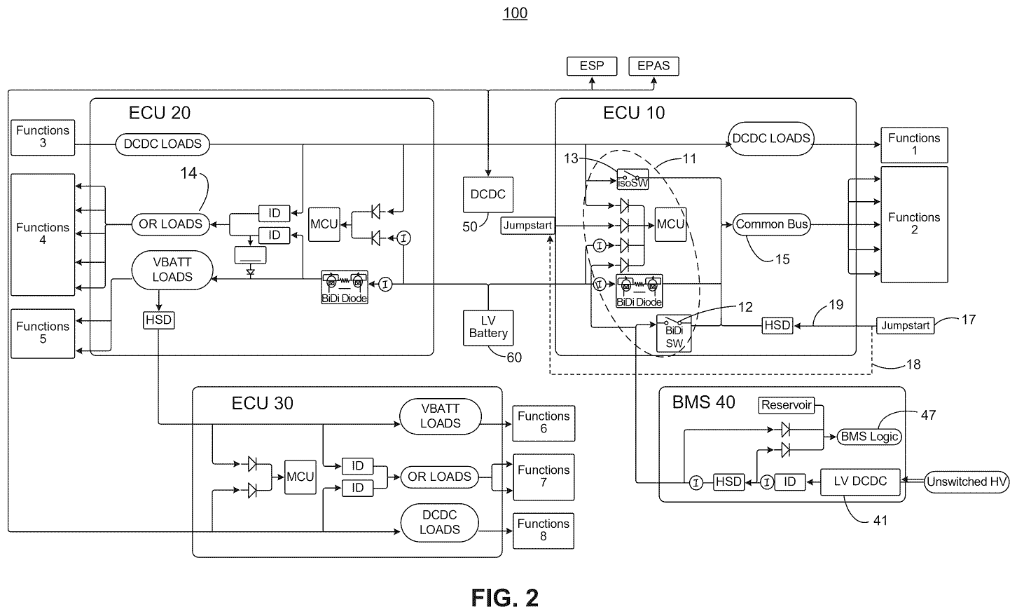

FIG. 2 illustrates an example block diagram of system 100 that may include a plurality of ECUs of vehicle 300. An ECU is an embedded system that may control one or more of the electrical systems or subsystems in a vehicle. The positioning and connections of ECU 10, ECU 20, or ECU 30 may provide for a level of redundancy for faults, which may be caused by collisions or other malfunctions. The design of system 100 may allow vehicle 300 to safely operate for a period after the fault, such as being able to drive vehicle 300 (e.g., steer, brake, or accelerate) to a safe position off of a roadway or being able to operate electronic controlled functions (e.g., door latches) of vehicle 300, among other things. As shown, ECU 10, ECU 20, and ECU 30 may be connected with DCDC 50 (also referred herein as DCDC bus 50) to operate DCDC loads and a low voltage (LV) battery 60 (e.g., 12V battery or LV battery bus 60) to operate LV battery loads. In an example, one or more ECUs (e.g., ECU 10) may include a fault isolation system 11. Fault isolation system 11 may include isolation switch or a bidirectional (Bidi) switch 12. In some configurations, in consideration of safety, only one ECU (e.g., ECU 10) may include fault isolation system 11. As shown, ECU 10 may include a common bus 15, which may operate slightly differently than other buses (e.g., OR load bus 14), as the common bus may allow for bidirectional power to be transmitted to and from LV battery 60 that may be a function of using fault isolation system 11. The common bus 15 (specific to ECU 10) allows power to flow bidirectionally, from LV battery 60 to DCDC 50, or from DCDC 50 to LV battery 60. The OR bus does not allow power to flow bidirectionally (it does not connect or isolate LV battery 60 and DCDC 50 networks). The other element, which is a shared attribute of both common bus 15 and OR load Bus 14, that in the event of a failure of the DCDC 50 or LV battery 60, the common bus 15 (or OR load Bus 14) will retain operation (e.g., will be available).

With continued reference to FIG. 2, each ECU may have on or more dedicated functions that may be powered by DCDC 50, LV battery 60, or LV DCDC 41. ECU 10 may operate functions 1, functions 2, and jumpstart functions. ECU 10 may be connected with jumpstart access 17 (e.g., wiring located in a rear portion 340 of vehicle 300). Jumpstart access 17 may allow an external power source (e.g., jumpstart pack) to connect with ECU 10 in order to jumpstart electronic functions of the vehicle, particularly when LV battery 60 is depleted. As further described herein, jumpstart access 17 may have multiple routes that include jumpstart route 18 (e.g., to microcontroller) and jumpstart route 19 (e.g., to Bidi switch 12). Functions 1 may include functions such as first row universal serial bus, or electronic stability program (ESP), among other things. Functions 2 may include functions such as right door latch, passenger seat motor, right headlamp, alarm module, or frunk latch, among other things. In this example, functions 1 of ECU 10 may only be powered by DCDC 50, while functions 2 of ECU 10 may be powered by DCDC 50 (which may be the primary power) or LV battery 60 (which may be the secondary power), which may be referred to common bus 15. ECU 10 may be located on the right front of vehicle 300 and therefore may operate functions primarily (e.g., most or all) for the right portion of vehicle 300.

As shown in FIG. 2, ECU 20 may operate functions 3, functions 4, and functions 5. Functions 3 may include functions such as front suspension valves, or autonomy control module, among other things. Functions 4 may include functions such as steering angle sensor, front wiper motor, left door latches, left headlamp, exterior near field communication (NFC), or on-board diagnostics (OBD) port, among other things. Functions 5 may include functions such as electric power assisted steering (EPAS), charge port door, interior NFC, or electric powered assisted breaking, among other things. In this example, functions 3 of ECU 20 may only be powered by DCDC 50 and functions 5 of ECU 20 may only be powered by LV battery 60. Functions 4 of ECU 20 may be powered by DCDC 50 (which may be the primary power) or LV battery 60 (which may be the secondary power), which may be referred to OR loads 14 (also referred herein as OR load bus 14). ECU 20 may be located on the left front of vehicle 300 and therefore may operate functions primarily (e.g., most or all) for the left portion of vehicle 300.

As shown in FIG. 2, ECU 30 may operate functions 6, functions 7, and functions 8. Functions 6 may include functions such as license plate lamp. Functions 7 may include functions such as rear vehicle access system sensors, liftgate latch, trailer brake, right lamp rear, or left lamp rear, among other things. Functions 8 may include functions such as right trailer brake lamp, or rear suspension valves, among other things. In this example, functions 8 of ECU 30 may only be powered by DCDC 50 and functions 6 of ECU 30 may only be powered by LV battery 60. Functions 7 of ECU 30 may be powered by DCDC 50 (which may be the primary power) or LV battery 60 (which may be the secondary power). ECU 30 may be located on the rear of vehicle 300 and therefore may operate functions primarily (e.g., most or all) for the rear portion of vehicle 300.

System 100 of FIG. 2 may include a battery management system (BMS) 40. BMS 40 may include BMLS logic 47 or LV DCDC 41, among other components. BMS 40 may be located at or near HV battery pack 310 of FIG. 1B, which LV DCDC 41 converts the HV DC to a lower voltage, such as 10 to 14V. LV DCDC 41 may help reduce the need for LV battery 60 for some operations, such as when vehicle 300 is in standby mode (e.g., parked). It is contemplated that the functions disclosed herein (e.g., functions 1 through functions 8) may be controlled by other ECUs or powered by any of the listed power sources.

The functionality associated with FIG. 2 and disclosed throughout may provide for the following: 1) may avoid loss of either bus for critical functions like ADAS or pulling over to the side of the road; 2) Preserving battery power to post crash critical functions (door unlock, hazard lighting, eCall, firing pyro, etc.); 3) powering the vehicle with continuous sleep power directly from the HV battery pack; 4) resilient to the loss of an ECU; or 5) resilient to the loss of a power bus.

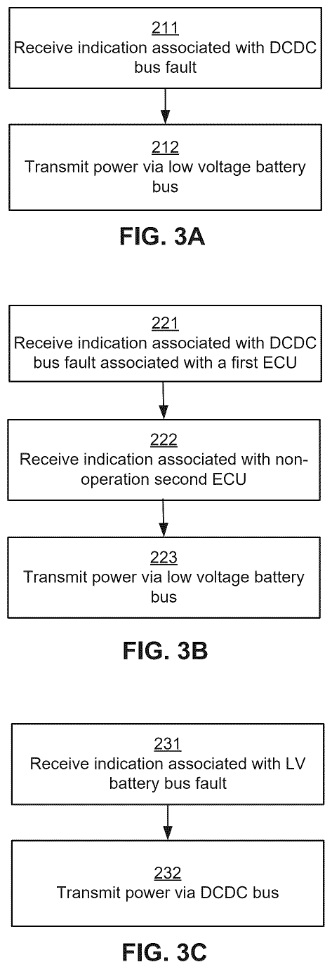

FIG. 3A illustrates an exemplary method for power bus switching. At step 211, an apparatus (e.g., a microcontroller unit or other device) may receive an indication that DCDC bus 50 has faulted in a manner that does not supply power to ECU 10. At step 212, based on the indication that DCDC bus 50 has faulted in the manner that does not supply power to ECU 10, the apparatus may provide instructions to transmit power using LV battery bus 60 to ECU 10 to enable functions 2 of ECU 10.

FIG. 3B illustrates an exemplary method for power bus switching. At step 221, an apparatus may receive an indication DCDC bus 50 has faulted in a manner that does not supply power to ECU 20. At step 222, the apparatus may receive an indication that ECU 10 is not operational and cannot function. At step 223, based on the indication that DCDC bus 50 has faulted in the manner that does not supply power to ECU 20, the apparatus may provide instructions to transmit power using LV battery bus 60 to ECU 20 to enable functions 4 and functions 5 of ECU 20. The functions 4 and functions 5 of ECU 20 may operate even with ECU 10 in a nonoperational status. ECU 30 may operate in a similar manner.

FIG. 3C illustrates an exemplary method for power bus switching. At step 231, an apparatus may receive an indication that LV battery bus 60 has faulted in a manner that does not supply power to ECU 30. At step 232, based on the indication that LV battery bus 60 has faulted in the manner that does not supply power to ECU 30, the apparatus may provide instructions to transmit power using that DCDC bus 50 to ECU 30 to enable functions 7 and functions 8 of ECU 30.

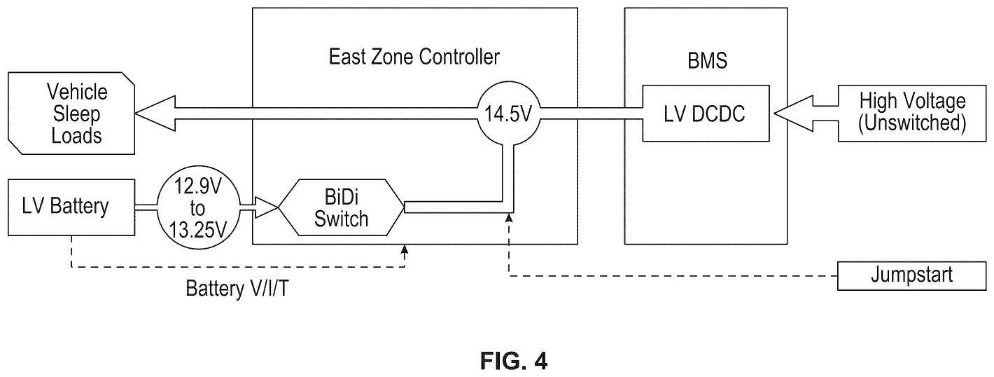

FIG. 4 illustrates an exemplary block diagram of power distribution components or functionality. Functions may include 1) BiDi switch during sleep “Diode Mode” for transient/wake support; 2) BiDi switch during drive “Fully Closed”; 3) BiDi switch during jumpstart “Fully Open” for controlled jumpstart; 4) Run Gear Guard with minimal range loss; 5) LV DCDC voltage set to 14.5V (for example) to not cycle 12V battery; 6) vehicle wakes off 12V battery status; or 7) BiDi switch allows a small current to keep the 12V battery float charged at all times.

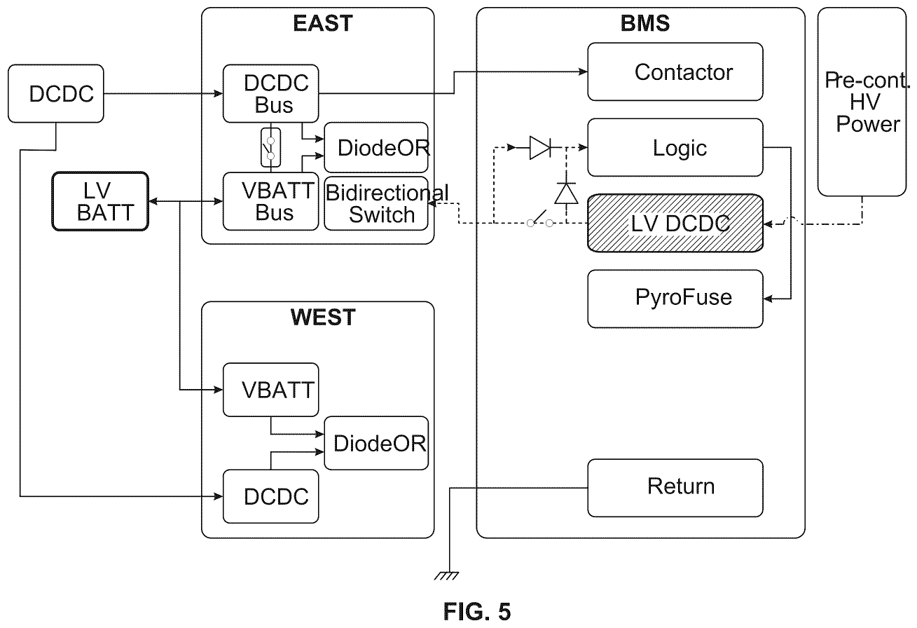

FIG. 5 illustrates an exemplary block diagram of power distribution components or functionality, which is similar to FIG. 2. BMS logic 47 may be used to operate a fuse such as pyrofuse 49. Pyrofuse 49 is a type of safety device used in electric vehicles (EVs) and other high-voltage systems to protect the electrical system in the event of a fault, such as a short circuit or a crash. The key characteristic of a pyrofuse is that it is designed to disconnect the high-voltage battery from the rest of the vehicle's electrical system in an emergency by using a small explosive charge to break the electrical connection.

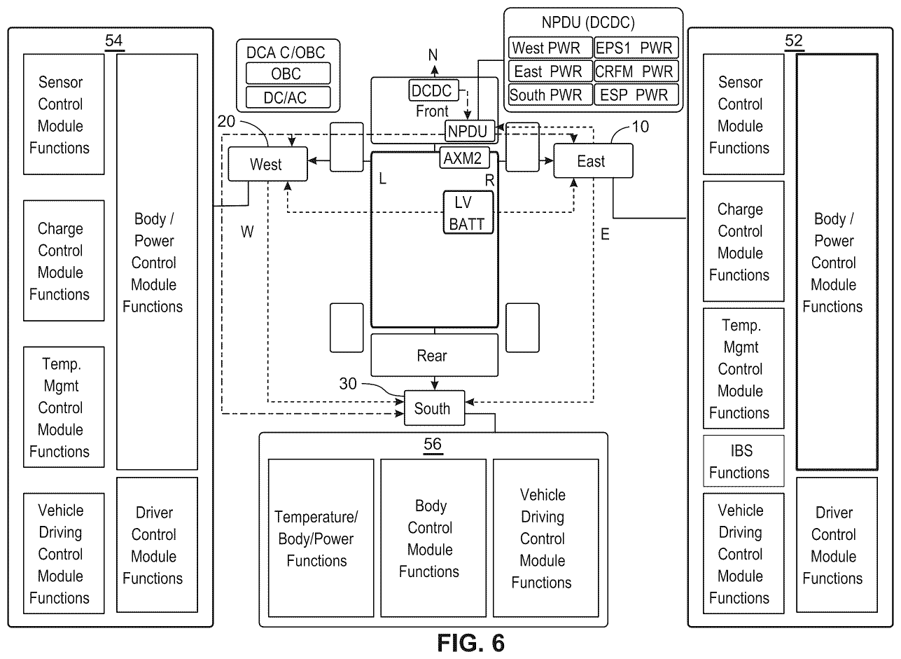

FIG. 6 illustrates an exemplary block diagram of components or functionality of vehicle 300, which may have similar connections or functions as shown in FIG. 2. EZC functions 52 may include sensor control module functions, charge control module functions, body/power control module functions, temperature management control module functions, intelligent battery sensor functions, vehicle driving control functions, or driver control module functions, among other functions which may be associated primarily with the right side of vehicle 300. WZC functions 54 may include sensor control module functions, charge control module functions, body/power control module functions, temperature management control module functions, vehicle driving control functions, or driver control module functions, among other functions which may be associated primarily with the left side of vehicle 300. SZC functions 56 may include body control module functions, vehicle driving control module functions, or temperature/body/power control module functions, among other functions which may be associated primarily with the rear of vehicle 300.

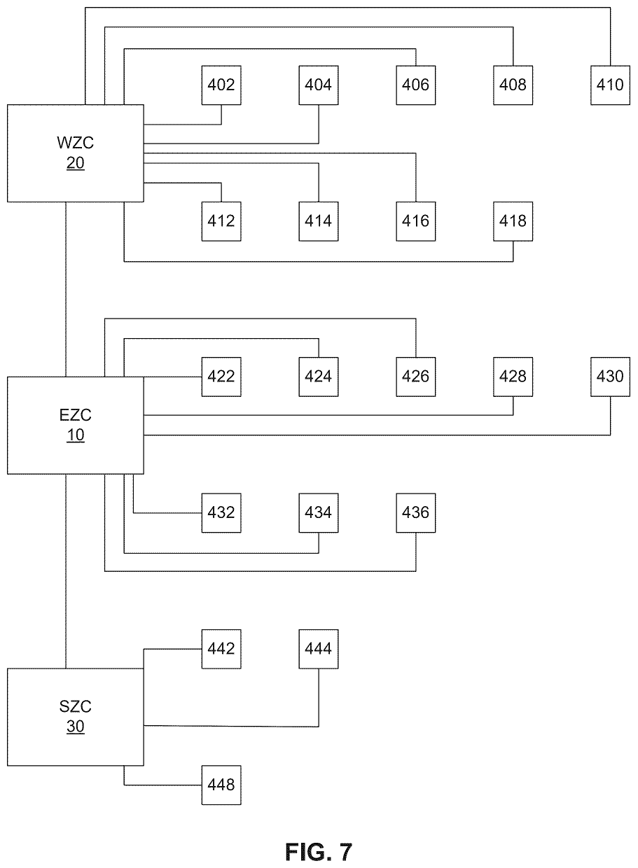

FIG. 7 illustrates an exemplary network associated with vehicle 300. Communication may occur using Controller Area Network (CAN), Ethernet, Local Interconnect Network (LIN) protocols, which may generally be used with vehicles. CAN was designed for high reliability for the harsh environment of the car electrical bus. LIN may be used for control of less critical modules on a vehicle. ECU 20, ECU 10, or ECU 30 may communicate with other components via Ethernet, CAN, or LIN protocols, among other things. Herein for simplicity, the modules have same or similar general names associated with the communication network connection.

ECU 20 may be associated with or manage one or more modules (or also referred herein as components), such as primary actuator CAN modules 402, secondary actuator CAN modules 404, platform CAN modules 406, motor CAN modules 408, headliner LIN modules 410, front left body LIN modules 412, rear left door LIN modules 414, front left door LIN modules 416, or hands on LIN modules 418, among others. Primary actuator CAN modules 402 may include steering column control module (SCCM), electronic power steering-primary module, electronic stability program (ESP) module, electromechanical brake booster module (e.g., power assisted breaking), restraints control module (e.g., crash detection and airbag deployment), or occupant classification sensor module. SCCM may add stalk controls for the user (e.g., wipers, turn signal, drive direction, etc.) EPAS may provide power assisted steering and autonomous steering actuation. ESP may provide stability control and anti-lock braking as well as autonomous braking actuation. Occupant classification sensor may provide occupant weight to the RCM in order to optimize airbag deployment strategy. Secondary actuator CAN modules 404 may be associated with a secondary backup CAN connection and secondary actuator CAN modules may include electronic power steering-secondary module, electronic stability program module, or electromechanical brake booster module. Platform CAN modules 406 may include a restraints control module (e.g., seatbelt).

Motor CAN modules 408 may include quad motor variants module, or dual motor variants module, among other modules. Quad or dual motor variants may include front inverters, front oil pumps, rear inverters, rear oil pumps, or the like. Headliner LIN modules 410 may include HMLK/IRVM/ISM/driver monitoring system (DMS), left reading courtesy light module, right reading courtesy light module, left third row dome, or right third row dome. Front left body LIN modules 412 may include radiator fan module, dew point sensor module, coolant pump module, pressure temperature sensor module, charge port indicator module, or frunk latch module, or the like. Rear left door LIN modules 414 may include rear left door light upper module, rear left door light lower module, rear left door map pocket light module, or rear left footwell light module, among other modules. Front left door LIN modules 416 may include front left door light upper module, front left door light lower module, front left door map pocket light module, front left switch pack module, or front left footwell light module, among other modules. Hands on modules 418 may include hands on wheel module or the like.

ECU 10 may be associated with or manage one or more modules (or also referred herein as components), such as body front CAN modules 422, access CAN modules 424, rear right door LIN modules 426, front right door LIN modules 428, instrument panel (IP) LIN modules 430, front right body LIN modules 432, or overhead console LIN modules 434, among others. Body front CAN modules 422 may include a right headlamp module, left headlamp module, front center lamp module, right directional indicator module, left directional indicator, amplifier module, DC-to-DC converter, onboard charger module, wireless charger module, or the like. Access CAN module 424 may include overhead console, right front fascia module, right rear fascia module, left front fascia module, left rear fascia module, or north front cabin side door handle module, among other modules. Rear right door LIN modules 426 may include a rear right door light upper module, rear right door light lower module, rear right door map pocket light module, or rear right footwell light module, among other modules. Front right door LIN modules 428 may include rear front door light upper module, front right door light lower module, front right door map pocket light module, passenger door handle module, or front right footwell light module, among other modules. Front right body LIN modules 432 may include a left or right active grill shutter module, coolant pump traction module, 5-way valve module, or electronic air compressor module. Overhead console LIN module 434 may include a rain light sensor, overhead console, pin spotlight, or the like.

IP LIN modules 430 may include center IP accent lights module, right IP accent lights module, left access light module, right steering wheel switches module, or left steering wheel switches modules.

With continued reference to FIG. 7, as disclosed herein, the network connections of components of vehicle 300 may be based on the geographical proximity of the components. In an example, if components are geographically closer to a west zone, then those components may be connected with ECU 20. There may be an exemption for some components to this proximity approach. A first example of such exemption may be associated with the IP LIN modules 430 which may be associated with lights in the dashboard area of vehicle 300. IP LIN modules 430 may include one or more lights on the left, one or more lights on the right, and one or more lights on the center. The IP lights may be connected to ECU 10, even though one or more lights on the left and one or more lights on the center are geographically closer to ECU 20. This approach significantly reduces the total delay between the activation of the first and last lights in the sequence. If the lights were divided between two separate networks (e.g., ECU 10 having two lights and ECU 20 having three lights), there may be complex synchronization procedures between the two zones to maintain the threshold level of synchronicity. Thus, the disclosed exemption for the IP lights allows for functional performance over geographical proximity in the multi-zonal architecture. This implementation may significantly reduce the need for intricate inter-zone synchronization mechanisms, resulting in a more efficient and responsive lighting control system. This architecture may significantly simplify the software control system, demonstrating a beneficial trade-off between hardware complexity and software simplicity.

In addition, FIG. 7 may include example connections with ECU 30. ECU 30 may include body rear CAN modules 442, console LIN modules 444, rear accessory LIN modules 448, or the like. Body rear CAN modules 442 may include a rear tail gate lamp module, right rear body side lamp module, left rear body side lamp module, tire pressure monitoring module, or the like. Console LIN modules 444 may include rear heating ventilation air conditioning mode actuator module, console tray light module, console bin lamp module, or the like. Rear accessory LIN modules 448 may include a gear guard latches module, auxiliary air compressor module, left third row cargo module, right third row cargo module coolant heater module, right liftgate puddle lamp module, left liftgate puddle lamp module, or the like.

The disclosed zonal architecture may overcome issues that are brought about by architectures that bring all power into one ECU and then distribute power. Such architectures may bring about a single point of failure. The disclosed subject matter may provide for a zonal power distribution architecture that routes power to each ECU separately, which may prevent any one ECU serving as a single point of failure for power distribution. The disclosed redundant power busing therefore may allow for power availability after a crash or other malfunctions for different functions, such as a vehicle to be driven for a period to be pulled over or operating electronic latches for a passenger to exit the vehicle.

The methods, systems, or apparatuses disclosed herein may be incorporated into electric vehicles or other devices. The methods, systems, or apparatuses disclosed herein may be incorporated into products, such as various feature specific electronic control units (ECUs).

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. There may be memory storage and a processor that reads instructions from such memory storage (e.g., methods disclosed herein executed by the processor). In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

Methods, systems, or apparatus with regard to zonal architecture for vehicle power distribution are disclosed herein. A vehicle may include an cast electronic control unit (ECU), a west ECU, and a south ECU. The east ECU may operate first components on a first side of a longitudinal axis of the vehicle, while the west ECU may operate second components on a second side of the longitudinal axis. The longitudinal axis may be defined as an imaginary line running from the front of the vehicle to the rear along its center, dividing the vehicle into the first and second sides. The south ECU may be positioned at the rear of the vehicle. The cast ECU may include a low voltage direct current to direct current (DCDC) support circuit block, which includes functions associated with low voltage DCDC switching or voltage monitor wakes. It is contemplated herein that position of the ECUs as described may be flipped on the horizontal axis, such as the east ECU and west ECU are in the rear of the vehicle and the south ECU (becomes the “north” ECU) and is positioned in the front of the vehicle. Other positioning of the ECUs throughout the vehicle are considered. All combinations (including the removal or addition of components) in this paragraph and the above paragraphs are contemplated in a manner consistent with other portions of the detailed description.

An apparatus, method, or system may comprise a first power bus for a low voltage (LV) battery; a second power bus for a direct current to direct current converter (DCDC); a first electronic control unit (ECU) located in a front of a vehicle, the first ECU connected with the first power bus and the second power bus; a second ECU located in the front of a vehicle, the second ECU connected with the first power bus and the second power bus; and a third ECU located in a rear of the vehicle, the third ECU connected with the first power bus and the second power bus. The LV battery bus may be associated with approximately a 12V battery, 13V battery, or 14V battery. A method may include receiving an indication associated with a fault of a direct current to direct current converter (DCDC) bus or a fault of a low voltage (LV) battery bus; and based on the receiving the indication, transmit power via the DCDC bus or the LV battery bus. All combinations (including the removal or addition of steps or components) in this paragraph and the above paragraphs are contemplated in a manner that is consistent with the other portions of the detailed description.

A vehicle, apparatus, or system may comprise an cast electronic control unit (ECU), wherein the east ECU communicates with first components of a first side of a longitudinal axis of the vehicle dividing the vehicle into the first side and a second side; and a west ECU, wherein the west ECU communicates with second components of the second side of the longitudinal axis of the vehicle, wherein the second components are not connected with the cast ECU and wherein the first components are not connected with the second components. The vehicle may further comprise a south ECU, wherein the south ECU communicates with third components in a rear of a horizontal axis of the vehicle dividing the vehicle into a front and the rear. The first components may comprise a front right door module or an instrument panel (IP) module, wherein the front right door module or the instrument panel (IP) module communicate with the cast ECU via local interconnect network (LIN) protocol. The first components may comprise a rear right door module or overhead console module, wherein the rear right door module or overhead console module communicate with the cast ECU via local interconnect network (LIN) protocol. All combinations (including the removal or addition of steps or components) in this paragraph and the above paragraphs are contemplated in a manner that is consistent with the other portions of the detailed description.

The longitudinal axis may be defined as an imaginary line running from a front of the vehicle to a rear of the vehicle along a center of the vehicle. The horizontal axis may be defined as an imaginary line running from the first side of the vehicle to a second side of the vehicle along the center of the vehicle. The cast ECU may be geographically positioned on the first side of the vehicle and the west ECU may be geographically positioned on the second side of the vehicle, wherein the first side and the second side are different. The first components of the east ECU may comprise a sensor control function, charge control function, temperature management function, vehicle driving control function, or driver control function. The second components of the west ECU may comprise a steering column control module, electromechanical brake booster module, or restraints control module. The third components of the south ECU may comprise a body control function or body power function. All combinations (including the removal or addition of steps or components) in this paragraph and the above paragraphs are contemplated in a manner that is consistent with the other portions of the detailed description.

The third components of the south ECU may comprise a gear guard latches module or auxiliary air compressor module, wherein the gear guard latches module or auxiliary air compressor module communicate with the south ECU via local interconnect network (LIN) protocol. The first components of the east ECU may comprise an instrument panel (IP) module, wherein the IP module comprises a first light on the first side and a second light on the second side. The cast ECU may be connected with a plurality of the first components using local interconnect network (LIN) protocol. The east ECU may be connected with a plurality of the first components using local interconnect network (LIN) protocol and controller area network (CAN) bus protocol. All combinations (including the removal or addition of steps or components) in this paragraph and the above paragraphs are contemplated in a manner that is consistent with the other portions of the detailed description.

An apparatus may comprise an east electronic control unit (ECU), wherein the cast ECU communicates with first components of a first side of a longitudinal axis of the apparatus dividing the vehicle into the first side and a second side; and a south ECU, wherein the south ECU communicates with third components in a rear of a horizontal axis of the apparatus dividing the apparatus into a front and the rear, wherein the third components are not connected with the cast ECU and wherein the first components are not connected with the third components. The apparatus may be a vehicle. The apparatus may further comprise a west ECU, wherein the west ECU communicates with second components of the second side of the longitudinal axis of the vehicle. The second components may comprise quad motor variants connected with the west ECU via a Controller Area Network (CAN) protocol. The first components may comprise headlamps connected with the east ECU via a Controller Area Network (CAN) protocol. The third components may comprise a rear tail gate lamp connected with the south ECU via a Controller Area Network (CAN) protocol. All combinations (including the removal or addition of steps) in this paragraph and the above paragraphs are contemplated in a manner that is consistent with the other portions of the detailed description.

What is claimed is:

1. A vehicle comprising:
a first electronic control unit (ECU), wherein the first ECU communicates with first components of a first side of a longitudinal axis of the vehicle dividing the vehicle into the first side and a second side; and
a second ECU, wherein the second ECU communicates with second components of the second side of the longitudinal axis of the vehicle, wherein the second components are not connected with the first ECU and wherein the first components are not connected with the second components.

2. The vehicle of claim 1, further comprising a third ECU, wherein the third ECU communicates with third components in a rear of a horizontal axis of the vehicle dividing the vehicle into a front and the rear.

3. The vehicle of claim 2, wherein the horizontal axis is defined as an imaginary line running from the first side of the vehicle to the second side of the vehicle along a center of the vehicle.

4. The vehicle of claim 1, wherein the first components comprise a front right door module or an instrument panel (IP) module, wherein the front right door module or the instrument panel (IP) module communicate with the first ECU via local interconnect network (LIN) protocol.

5. The vehicle of claim 1, wherein the first components comprise a rear right door module or an overhead console module, wherein the rear right door module or the overhead console module communicate with the first ECU via local interconnect network (LIN) protocol.

6. The vehicle of claim 1, wherein the longitudinal axis is defined as an imaginary line running from a front of the vehicle to a rear of the vehicle along a center of the vehicle.

7. The vehicle of claim 1, wherein the first ECU is geographically positioned on the first side of the vehicle and the second ECU is geographically positioned on the second side of the vehicle, wherein the first side and the second side are different.

8. The vehicle of claim 1, wherein the first components of the first ECU comprise a sensor control function, charge control function, temperature management function, vehicle driving control function, or driver control function.

9. The vehicle of claim 1, wherein the second components of the second ECU comprise a steering column control module, electromechanical brake booster module, or restraints control module.

10. The vehicle of claim 2, wherein the third components of the third ECU comprise a body control function or body power function.

11. The vehicle of claim 2, wherein the third components of the third ECU comprise a gear guard latches module or an auxiliary air compressor module, wherein the gear guard latches module or the auxiliary air compressor module communicate with the third ECU via local interconnect network (LIN) protocol.

12. The vehicle of claim 1, wherein the first components of the first ECU comprise an instrument panel (IP) module, wherein the IP module comprises a first light on the first side and a second light on the second side.

13. The vehicle of claim 1, wherein the first ECU is connected with a plurality of the first components using local interconnect network (LIN) protocol.

14. The vehicle of claim 1, wherein the first ECU is connected with a plurality of the first components using local interconnect network (LIN) protocol and controller area network (CAN) bus protocol.

15. An apparatus comprising:
a first electronic control unit (ECU), wherein the first ECU communicates with first components of a first side of a longitudinal axis of the apparatus dividing the apparatus into the first side and a second side; and
a third ECU, wherein the third ECU communicates with third components in a rear of a horizontal axis of the apparatus dividing the apparatus into a front and the rear, wherein the third components are not connected with the first ECU and wherein the first components are not connected with the third components.

16. The apparatus of claim 15, wherein the apparatus is a vehicle.

17. The apparatus of claim 15, further comprising a second ECU, wherein the second ECU communicates with second components of the second side of the longitudinal axis of the apparatus.

18. The apparatus of claim 17, wherein the second components comprise quad motor variants connected with the second ECU via a Controller Area Network (CAN) protocol.

19. The apparatus of claim 15, wherein the first components comprise headlamps connected with the first ECU via a Controller Area Network (CAN) protocol.

20. The apparatus of claim 15, wherein the third components comprise a rear tail gate lamp connected with the third ECU via a Controller Area Network (CAN) protocol.
